(19) United States
(12) Patent Application Publication
(10) Pub. No.: US 2017/0117628 A1
(43) Pub. Date: Apr. 27, 2017

(54) VEHICLE PHASED ARRAY ANTENNA PATTERN GENERATION

(71) Applicant: Ford Global Technologies, LLC, Dearborn, MI (US)

(72) Inventors: Lawrence Banasky, Livonia, MI (US); John Frederick Locke, Waterford, MI (US)

(21) Appl. No.: 14/924,227

(22) Filed: Oct. 27, 2015

(51) Int. Cl. H01Q 3/34; H01Q 3/24; H01Q 1/32

(52) U.S. Cl. CPC H01Q 3/34; H01Q 1/3233; H01Q 3/24

(57) ABSTRACT

A communication system for a vehicle includes a phased array antenna and a controller. The phased array antenna has a plurality of elements. The controller may be configured to select a subset of the elements to beam form a main lobe of a radiation pattern of the antenna based on a speed and steering angle of the vehicle. Also, the controller may be configured to select a subset of the elements and shift a phase of a signal emitted from each of the subset of the elements to beam form a main lobe of a radiation pattern of the antenna based on a speed and a change in speed of the vehicle. Further, the controller may be configured to select the subset of the elements based on a signal indicative of a location of the vehicle and a map database of a surrounding area of the location.

### TECHNICAL FIELD

This application is generally related to configuration of an antenna array for a vehicle to provide directional gain.

### BACKGROUND

Drivers of vehicles have a constantly growing amount of information to observe and process to maneuver safely while driving on the open road. Drivers must not only know about and adhere to the rules of the road in their own right, but they must also be aware of what nearby vehicles are doing. Although many cars have instrumentation and sensors such as radar or ultrasound to detect obstacles or other vehicles, the range of these sensors is limited to a few car lengths, and the sensors are typically not able to detect objects past an obstruction therebetween. Vehicle to vehicle (V2V) and vehicle to infrastructure (V2I) communication systems allow vehicles to communicate and share information allowing the drivers to focus on operation of the vehicle with additional information about the vehicles. The range of V2V and V2I is typically limited to a few hundred meters and is highly dependant upon whether obstacles are between an antenna of the communication system and the other party communicated with.

### SUMMARY

A communication system for a vehicle includes a phased array antenna and a controller. The phased array antenna has a plurality of elements. The controller is configured to select a subset of the elements to beam form a main lobe of a radiation pattern of the antenna based on a speed and steering angle of the vehicle.

A communication system for a vehicle includes a phased array antenna having a plurality of elements and a controller. The controller is configured to select a subset of the elements and shift a phase of a signal emitted from each of the subset of the elements to beam form a main lobe of a radiation pattern of the antenna based on a speed and a change in speed of the vehicle.

A vehicle includes a phased array antenna having a plurality of elements and a controller. The controller is configured to select a subset of the elements and shift a phase of a signal emitted from each of the subset of the elements to beam form a main lobe of a radiation pattern of the antenna based on a change in speed of the vehicle.

### BRIEF DESCRIPTION OF THE DRAWINGS

FIGS. 1A and 1B are an exemplary block topology of a vehicle infotainment system.

FIG. 2 is an exemplary illustration of a vehicle communication system including a phased array antenna.

FIG. 3A is a 2-dimensional illustration of an antenna system configured to produce a radiation pattern using a phased array antenna of a vehicle having approximately equal gain throughout 360 degrees.

FIG. 3B is a 2-dimensional illustration of an antenna system configured to produce a radiation pattern using a phased array antenna of a vehicle while a location of the vehicle is proximate to a tunnel wall.

FIG. 4A is a 2-dimensional illustration of an antenna system configured to produce a radiation pattern using a phased array antenna of a vehicle having increased gain to the front of the vehicle and behind the vehicle.

FIG. 4B is a 2-dimensional illustration of an antenna system configured to produce a radiation pattern using a phased array antenna of a vehicle having increased gain to the front of the vehicle and behind the vehicle while a location of the vehicle is proximate to a tunnel wall.

FIG. 5 is a 2-dimensional illustration of an antenna system configured to produce a radiation pattern using a phased array antenna of a vehicle having increased gain along 2 frontal lobes and behind the vehicle.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The embodiments of the present disclosure generally provide for a plurality of circuits or other electrical devices. All references to the circuits and other electrical devices and the functionality provided by each, are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any one or more of the electric devices may be configured to execute a computer-program that is embodied in a non-transitory computer readable medium that is programmed to perform any number of the functions as disclosed.

This disclosure, among other things, proposes an antenna system used in communication systems and methods for vehicle to vehicle (V2V), vehicle to infrastructure (V2I) and vehicle to cloud communication. The antenna system has the ability to rapidly alter its configuration to adapt to changes in vehicle operation, geographical conditions, and currently detected communication channels. Due to the requirement for rapid adaption and communication, the use of Dedicated Short Range Communication (DSRC) is typically used. Cellular networks may be used; however, latency concerns with cellular networks need to be addressed. The vehicle operation includes information from many modules in the vehicle including a steering column control module (SCCM), a powertrain control module (PCM), a collision avoidance system, a parking assistance module, a side or blind spot detection system, a transmission control module, a global positioning system (GPS) module, a antilock brake system (ABS) module, a Dedicated Short Range Communications (DSRC) module and an electronic stability control module (ESC). The antenna system may be a phased array antenna. A phased array antenna is composed of multiple radiating elements each with a phase shifter. Beams may be formed by shifting the phase of the signal emitted from each of the radiating elements, to provide constructive/destructive interference to steer the beams in the desired direction. Also, beams may be formed by selecting a subset of elements and shifting the phase of the signal emitted from each of the selected subset of radiating elements, to provide constructive/destructive interference to steer the beams in the desired direction.

During V2V communication, a vehicle traveling on a highway may have a limited time to adjust the antenna and beam form or steer the radiation pattern to optimize communication including reception and transmission with predicted targets. One method is to adjust the phase of each radiating element or each of the subset of radiating elements based on a signal from a SCCM or steering angle sensor. The signal from the steering angle sensor is indicative of an intended travel path of the vehicle and may be used to steer the beam in the direction the vehicle will be traveling. Another method is to adjust the phase of each radiating element or each of the subset of radiating elements based on a signal from a PCM, a wheel speed sensor, a transmission control module, or a driveshaft rotational speed. Based on the signal indicative of a speed of the vehicle, the shape of the beam may be adjusted. For example, when a vehicle is stationary or traveling a slow speed, like 15 miles per hour, the beam pattern may be circular when viewed on a plane. The spherical radiation pattern (seen as a circle on a single plane) may be beneficial to communicate with targets in all directions from the vehicle. As the vehicle is in motion, the radiation pattern may be adjusted to increase in a direction of probable targets. As the vehicle accelerates, it may be advantageous to change the pattern such that at least one lobe of the RF pattern is increased in front of the vehicle allowing an increase in communication range with targets in front of the vehicle. This communication range increase in front of the vehicle may increase a response time with respect to messages communicated with a vehicle infrastructure or other vehicles in front of the vehicle. Likewise, as the vehicle decelerates, it may be advantageous to change the pattern such that at least one lobe of the RF pattern is increased to the rear of the vehicle allowing increased communication with targets in behind the vehicle. This communication range increase behind the vehicle may increase a response time with respect to messages communicated with other vehicles behind the vehicle or a vehicle infrastructure. This response time increase may allow other vehicles behind the vehicle to brake/decelerate or in the event of a road closure, to take a nearby exit to avoid the slowdown.

The antenna system may also receive global positioning system (GPS) data. A controller of the antenna system may, based on the GPS data, adjust the phase of each radiating element or each of the subset of radiating elements. The controller may determine of a location of the vehicle is near a wall, or tunnel and in response to the determination, adjust the phase of each radiating element or each of the subset of radiating elements such that at least one lobe of the RF pattern is increased to extend to the front of the vehicle allowing an increase in communication range with targets in front of the vehicle or at least one lobe of the RF pattern is increased to extend behind the vehicle allowing an increase in communication range with targets behind the vehicle. By beam forming the RF pattern to the front and rear of the vehicle when proximate to a wall, building, or in a tunnel, the antenna system may decrease interference due to reflections off of surfaces of those structures. Also, the antenna system may use GPS data to beam form the RF pattern in a direction of an infrastructure antenna to increase communication reliability and signal strength. The antenna system may be coupled with a standalone embedded modem, a standalone transceiver, or a transceiver integrated into an infotainment system.

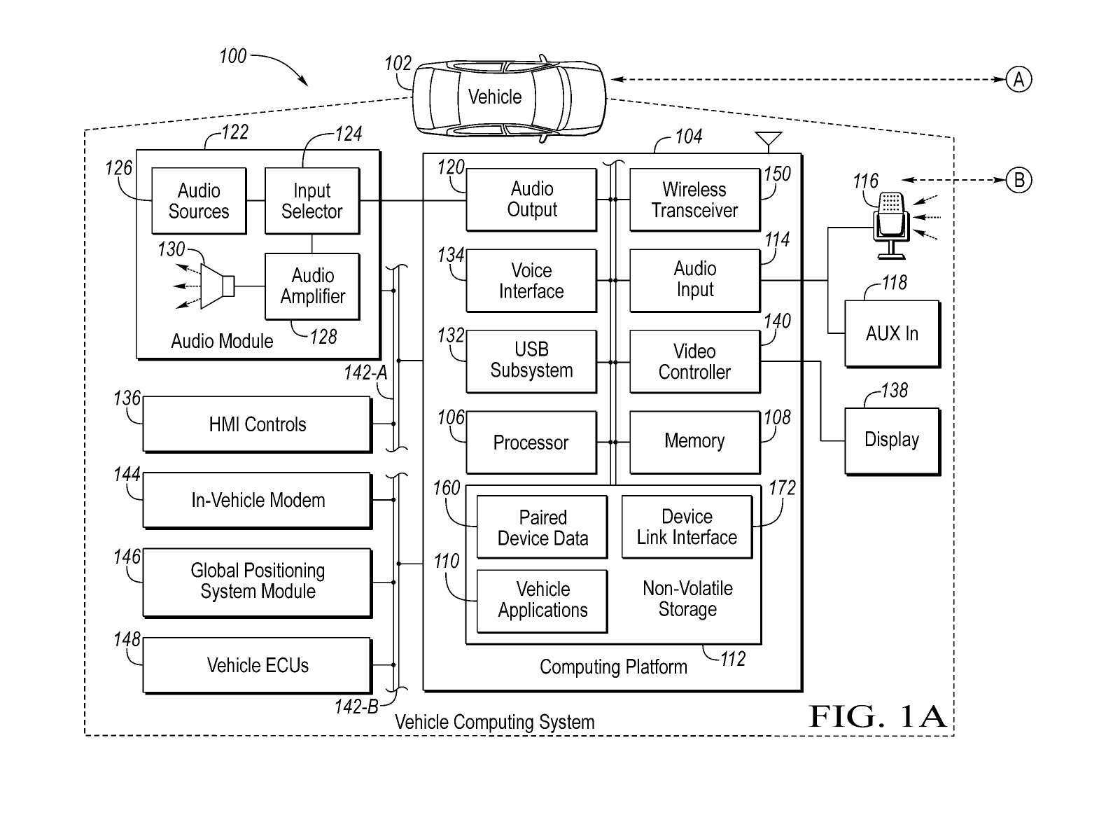

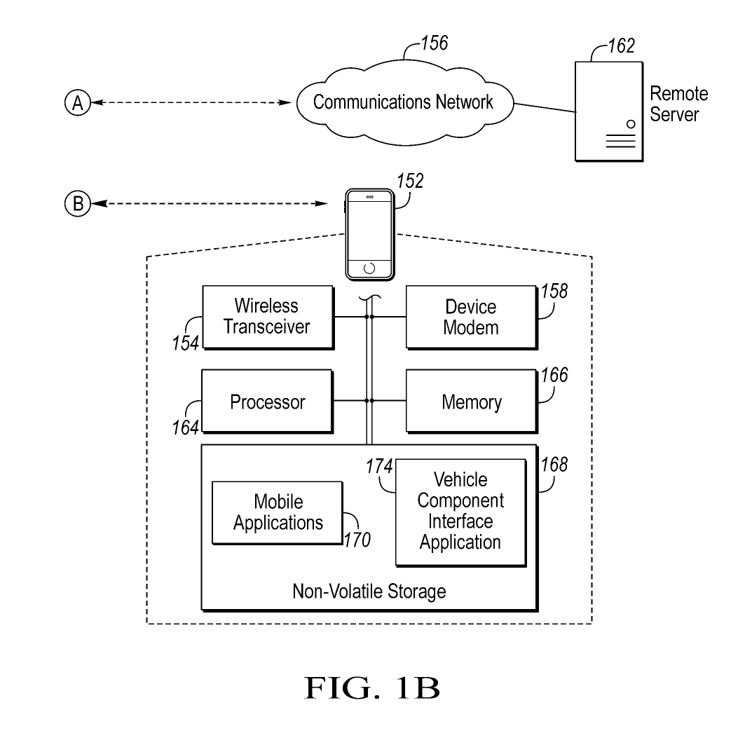

FIGS. 1A and 1B illustrate an example diagram of a system 100 that may be used to provide telematics services to a vehicle 102. The vehicle 102 may be one of various types of passenger vehicles, such as a crossover utility vehicle (CUV), a sport utility vehicle (SUV), a truck, a recreational vehicle (RV), a boat, a plane or other mobile machine for transporting people or goods. Telematics services may include, as some non-limiting possibilities, navigation, turn-by-turn directions, vehicle health reports, local business search, accident reporting, and hands-free calling. In an example, the system 100 may include the SYNC system manufactured by The Ford Motor Company of Dearborn, Mich. It should be noted that the illustrated system 100 is merely an example, and more, fewer, and/or differently located elements may be used.

The computing platform 104 may include one or more processors 106 configured to perform instructions, commands and other routines in support of the processes described herein. For instance, the computing platform 104 may be configured to execute instructions of vehicle applications 110 to provide features such as navigation, accident reporting, satellite radio decoding, and hands-free calling. Such instructions and other data may be maintained in a non-volatile manner using a variety of types of computer-readable storage medium 112. The computer-readable medium 112 (also referred to as a processor-readable medium or storage) includes any non-transitory medium (e.g., a tangible medium) that participates in providing instructions or other data that may be read by the processor 106 of the computing platform 104. The processor may also be multiple processors in multiple computing units which each perform a part of the overall driver alert. For example, one processor may perform audible alert functions, located in the audio module (122), while a different processor in the video controller (140) handles the visual alert, predicated from the same alert message. Computer-executable instructions may be compiled or interpreted from computer programs created using a variety of programming languages and/or technologies, including, without limitation and either alone or in combination, Java, C, C++, C#, Objective C, Fortran, Pascal, Java Script, Python, Perl, and PL/SQL.

The computing platform 104 may be provided with various features allowing the vehicle occupants to interface with the computing platform 104. For example, the computing platform 104 may include an audio input 114 configured to receive spoken commands from vehicle occupants through a connected microphone 116, and auxiliary audio input 118 configured to receive audio signals from connected devices. The auxiliary audio input 118 may be a physical connection, such as an electrical wire or a fiber optic cable, or a wireless input, such as a BLUETOOTH audio connection. In some examples, the audio input 114 may be configured to provide audio processing capabilities, such as pre-amplification of low-level signals, and conversion of analog inputs into digital data for processing by the processor 106.

The computing platform 104 may also provide one or more audio outputs 120 to an input of an audio module 122 having audio playback functionality. In other examples, the computing platform 104 may provide the audio output to an occupant through use of one or more dedicated speakers (not illustrated). The audio module 122 may include an input selector 124 configured to provide audio content from a selected audio source 126 to an audio amplifier 128 for playback through vehicle speakers 130 or headphones (not illustrated). The audio sources 126 may include, as some examples, decoded amplitude modulated (AM) or frequency modulated (FM) radio signals, and audio signals from compact disc (CD) or digital versatile disk (DVD) audio playback. The audio sources 126 may also include audio received from the computing platform 104, such as audio content generated by the computing platform 104, audio content decoded from flash memory drives connected to a universal serial bus (USB) subsystem 132 of the computing platform 104, and audio content passed through the computing platform 104 from the auxiliary audio input 118.

The computing platform 104 may utilize a voice interface 134 to provide a hands-free interface to the computing platform 104. The voice interface 134 may support speech recognition from audio received via the microphone 116 according to grammar associated with available commands, and voice prompt generation for output via the audio module 122. In some cases, the system may be configured to temporarily mute or otherwise override the audio source specified by the input selector 124 when an audio prompt is ready for presentation by the computing platform 104 and another audio source 126 is selected for playback.

The computing platform 104 may also receive input from human-machine interface (HMI) controls 136 configured to provide for occupant interaction with the vehicle 102. For instance, the computing platform 104 may interface with one or more buttons or other HMI controls configured to invoke functions on the computing platform 104 (e.g., steering wheel audio buttons, a push-to-talk button, instrument panel controls, etc.). The computing platform 104 may also drive or otherwise communicate with one or more displays 138 configured to provide visual output to vehicle occupants by way of a video controller 140. In some cases, the display 138 may be a touch screen further configured to receive user touch input via the video controller 140, while in other cases the display 138 may be a display only, without touch input capabilities.

The computing platform 104 may be further configured to communicate with other components of the vehicle 102 via one or more in-vehicle networks 142. The in-vehicle networks 142 may include one or more of a vehicle controller area network (CAN), an Ethernet network, and a media oriented system transfer (MOST), as some examples. The in-vehicle networks 142 may allow the computing platform 104 to communicate with other vehicle 102 systems, such as a vehicle modem 144 (which may not be present in some configurations), a global positioning system (GPS) module 146 configured to provide current vehicle 102 location and heading information, and various vehicle ECUs 148 configured to cooperate with the computing platform 104. As some non-limiting possibilities, the vehicle ECUs 148 may include a powertrain control module configured to provide control of engine operating components (e.g., idle control components, fuel delivery components, emissions control components, etc.) and monitoring of engine operating components (e.g., status of engine diagnostic codes); a body control module configured to manage various power control functions such as exterior lighting, interior lighting, keyless entry, remote start, and point of access status verification (e.g., closure status of the hood, doors and/or trunk of the vehicle 102); a radio transceiver module configured to communicate with key fobs or other local vehicle 102 devices; and a climate control management module configured to provide control and monitoring of heating and cooling system components (e.g., compressor clutch and blower fan control, temperature sensor information, etc.). Other ECUs 148 include a steering column control module (SCCM), a powertrain control module (PCM), a collision avoidance system, a parking assistance module, a side or blind spot detection system, a transmission control module, a global positioning system (GPS) module, a antilock brake system (ABS) module, a Dedicated Short Range Communications (DSRC) module and an electronic stability control module (ESC)

As shown, the audio module 122 and the HMI controls 136 may communicate with the computing platform 104 over a first in-vehicle network 142A, and the vehicle modem 144, GPS module 146, and vehicle ECUs 148 may communicate with the computing platform 104 over a second in-vehicle network 142B. In other examples, the computing platform 104 may be connected to more or fewer in-vehicle networks 142. Additionally or alternately, one or more HMI controls 136 or other components may be connected to the computing platform 104 via different in-vehicle networks 142 than shown, or directly without connection to an in-vehicle network 142.

The computing platform 104 may also be configured to communicate with mobile devices 152 of the vehicle occupants. The mobile devices 152 may be any of various types of portable computing device, such as cellular phones, tablet computers, smart watches, laptop computers, portable music players, or other devices capable of communication with the computing platform 104. In many examples, the computing platform 104 may include a wireless transceiver 150 (e.g., a BLUETOOTH module, a ZIGBEE transceiver, a Wi-Fi transceiver, an IrDA transceiver, an RFID transceiver, a Dedicated Short Range Communications (DSRC) transceiver, etc.) configured to communicate with a compatible wireless transceiver 154 of the mobile device 152. The wireless modules may transmit data at a carrier frequency or a center frequency. The center frequency is an important aspect of a wireless system by impacting noise immunity and bandwidth. For example, typical remote keyless entry systems operate at 315 MHz in the United States, and 433 MHz in Europe, while WiFi and Bluetooth may operate at frequencies including frequencies over 2 GHz such as 2.4 GHz. Additionally or alternately, the computing platform 104 may communicate with the mobile device 152 over a wired connection, such as via a USB connection between the mobile device 152 and the USB subsystem 132.

The communications network 156 may provide communications services, such as packet-switched network services (e.g., Internet access, VoIP communication services), to devices connected to the communications network 156. An example of a communications network 156 may include a cellular telephone network. Mobile devices 152 may provide network connectivity to the communications network 156 via a device modem 158 of the mobile device 152. To facilitate the communications over the communications network 156, mobile devices 152 may be associated with unique device identifiers (e.g., mobile device numbers (MDNs), Internet protocol (IP) addresses, etc.) to identify the communications of the mobile devices 152 over the communications network 156. In some cases, occupants of the vehicle 102 or devices having permission to connect to the computing platform 104 may be identified by the computing platform 104 according to paired device data 160 maintained in the storage medium 112. The paired device data 160 may indicate, for example, the unique device identifiers of mobile devices 152 previously paired with the computing platform 104 of the vehicle 102, such that the computing platform 104 may automatically reconnect to the mobile devices 152 referenced in the paired device data 160 without user intervention.

When a mobile device 152 that supports network connectivity is paired with the computing platform 104, the mobile device 152 may allow the computing platform 104 to use the network connectivity of the device modem 158 to communicate over the communications network 156 with the remote telematics services 162. In one example, the computing platform 104 may utilize a data-over-voice plan or data plan of the mobile device 152 to communicate information between the computing platform 104 and the communications network 156. Additionally or alternately, the computing platform 104 may utilize the vehicle modem 144 to communicate information between the computing platform 104 and the communications network 156, without use of the communications facilities of the mobile device 152.

Similar to the computing platform 104, the mobile device 152 may include one or more processors 164 configured to execute instructions of mobile applications 170 loaded to a memory 166 of the mobile device 152 from storage medium 168 of the mobile device 152. In some examples, the mobile applications 170 may be configured to communicate with the computing platform 104 via the wireless transceiver 154 and with the remote telematics services 162 or other network services via the device modem 158. The computing platform 104 may also include a device link interface 172 to facilitate the integration of functionality of the mobile applications 170 into the grammar of commands available via the voice interface 134 as well as into display 138 of the computing platform 104. The device link interfaced 172 may also provide the mobile applications 170 with access to vehicle information available to the computing platform 104 via the in-vehicle networks 142. Some examples of device link interfaces 172 include the SYNC APPLINK component of the SYNC system provided by The Ford Motor Company of Dearborn, Mich., the CarPlay protocol provided by Apple Inc. of Cupertino, Calif., or the Android Auto protocol provided by Google, Inc. of Mountain View, Calif. The vehicle component interface application 174 may be once such application installed to the mobile device 152.

The vehicle component interface application 174 of the mobile device 152 may be configured to facilitate access to one or more vehicle 102 features made available for device configuration by the vehicle 102. In some cases, the available vehicle 102 features may be accessible by a single vehicle component interface application 174, in which case the vehicle component interface application 174 may be configured to be customizable or to maintain configurations supportive of the specific vehicle 102 brand/model and option packages. In an example, the vehicle component interface application 174 may be configured to receive, from the vehicle 102, a definition of the features that are available to be controlled, display a user interface descriptive of the available features, and provide user input from the user interface to the vehicle 102 to allow the user to control the indicated features. As exampled in detail below, an appropriate mobile device 152 to display the vehicle component interface application 174 may be identified, and a definition of the user interface to display may be provided to the identified vehicle component interface application 174 for display to the user.

Systems such as the system 100 and system 200 may require mobile device 152 pairing with the computing platform 104 and/or other setup operations. However, as explained in detail below, a system may be configured to allow vehicle occupants to seamlessly interact with user interface elements in their vehicle or with any other framework-enabled vehicle, without requiring the mobile device 152 or wearable device 152 to have been paired with or be in communication with the computing platform 104.

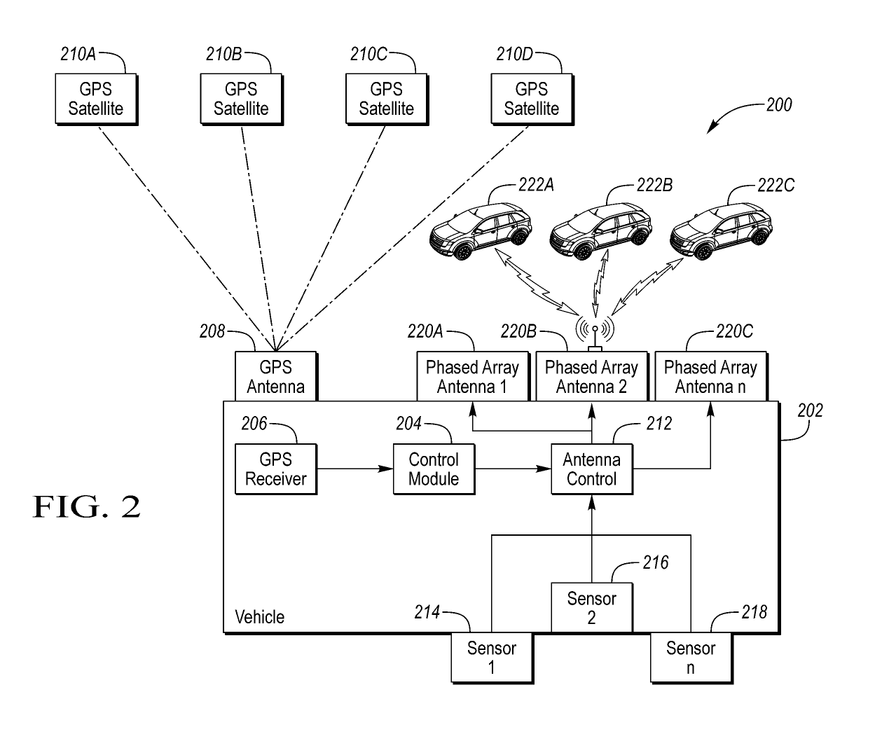

FIG. 2 is an exemplary illustration of a vehicle communication system 200 including a phased array antenna 220. The communication system 200 includes a vehicle 202 having a control module 204 and a Global positioning System (GPS) receiver 206 coupled with the control module 204. GPS is a network of approximately 30 GPS satellites 210 orbiting the Earth at an altitude of approximately 20,000 km. The GPS receiver 206 has at least one GPS antenna 208 use to receive a signal from GPS satellites 210A-210D. The GPS receiver calculates a distance from each satellite 210 the receiver 206 is in contact with. In this example, the receiver 206 is coupled with 4 satellites, 210A, 210B, 210C, and 210D via the GPS antenna 208. The GPS receiver 206 communicates information based on signals received via the GPS antenna 208. The control module 204 may include a controller or processor that may determine a location of the vehicle 202 based on the signals received via the GPS antenna 208. A sphere for each satellite is calculated based on a distance from each satellite. The distance is determined by measuring a time that a radio wave travels from the satellite to the receiver. A location of the vehicle is calculated by triangulation, which is calculating the point of intersection of the spheres generated based on distances between each satellite and the vehicle 202. The Based on the location of the vehicle and a map of the surrounding area of the location, the control module 204 may identify buildings, antennas, terrestrial topologies, tunnels, bridges, and other structures having RF characteristics about which a radiation pattern of at least one antenna may be steered towards or steered away from. For example, in a tunnel, a radiation pattern may be steered to a front and rear of the vehicle to minimize reflections of the emitted radiation off of the structures. Alternatively, a radiation pattern may be steered towards an antenna to increase reception. Another example is beam forming the radiation pattern such that a main lobe of the pattern is in a plurality of directions. The beam forming into a plurality of directions may be beneficial, for example, in a rural setting when a vehicle is approaching a cross street, by concentrating the radiation pattern of the main lobe towards a frontal area of the vehicle, the vehicle may be able to communicate with vehicle expected to travel close to in the future at the intersection of the cross street.

Based on the location of the vehicle 202 and structures proximate to the location or other aspects of the location, a beam form signal may be communicated to the antenna control 212. In this example, the antenna control 212 is coupled with the control module 204 and a plurality of sensors including sensor 1 214, sensor 2 216 and sensor n 218. A sensor may be a steering angle sensor configured to detect or measure an angle of a steering wheel. Typically, front wheels of the vehicle 202 are coupled with the steering wheel such that a direction of travel of the vehicle 202 is determined by the steering angle. Another sensor may be a wheel speed sensor configured to detect or measure a rotational speed of a wheel of the vehicle 202. A speed of the vehicle 202 or a change in speed of the vehicle 202 may be determined by the wheel speed sensor. Yet another sensor may include a turn indicator coupled with a body control module configured to illuminate turn signals of the vehicle 202. Other sensors of the vehicle may include any vehicle sensor coupled with the antenna control 212 either directly or via a vehicle data bus such as CAN, LIN, FlexRay, Ethernet, MOST, etc.

Here, the antenna control 212 is coupled with a plurality of phased array antennae 220, shown are three antennae 220A, 220B, and 220C. Each phased array antenna 220 includes a plurality of antenna elements. Each phased array antenna 220 may include a switch to select or deselect a specific antenna element, a combiner to cumulate or combine each signal from each element selected by each switch, and a phase shifter in series with each switch and each element for shifting the phase of the signal received from the antenna element. Based on the selection of individual elements of a phased array antenna and a shift in phase of the subset of antenna elements selected, a radiation pattern may be adjusted to concentrate the reception and RF pattern of the antenna 220. In this illustration, the vehicle 202 is in communication with other vehicles 222 via an RF link; however, the antenna may be used to communicate with a vehicle infrastructure, or any other RF system.

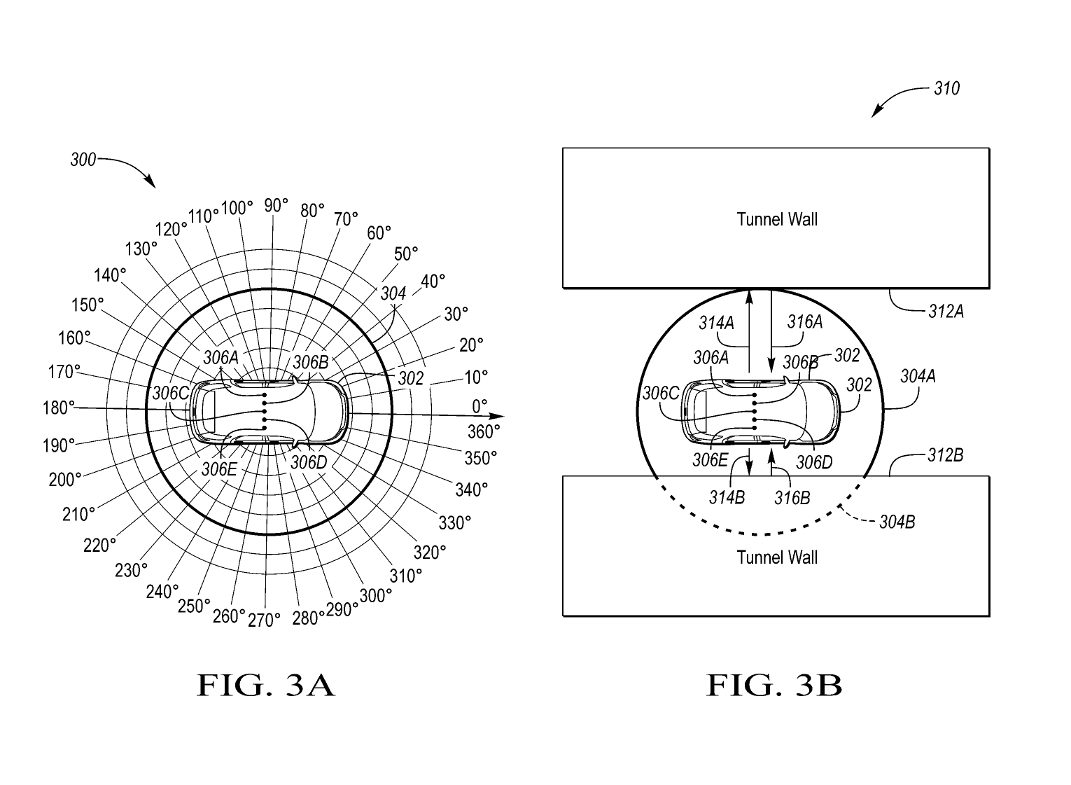

FIG. 3A is a 2-dimensional illustration of an antenna system 300 of a vehicle 302 configured to produce a radiation pattern 304 using a phased array antenna 306 with approximately equal gain throughout 360 degrees. This pattern is typical of simple dipole antenna configuration. FIG. 3B is a 2-dimensional illustration of an antenna system 310 of a vehicle 302 configured to produce a radiation pattern 304 using a phased array antenna 306 of a vehicle while a location of the vehicle is proximate to a tunnel wall 312. Here, the radiation pattern 304 is generally spherical such that when viewed along a single plane it appears circular. The radiation pattern 304 includes a portion of the pattern 304A transmitted into non-obstructing space. The non-obstructed RF signal 314A transmitted does not contact any objects such as tunnel wall 312A and thus has minimal non-obstructed reflections 316A. A second portion of the pattern 304B is transmitted such that the obstructed RF signal 314B may reflect off of the tunnel wall 312B and a reflected signal 316B may interfere with reception by the antenna 306. Based on a prior selection of elements, reception strength, a magnitude of reflections, and weather conditions, a controller may select a different group of elements, such as a subset of all elements or shift a phase of the selected elements to concentrate the RF energy to form a main lobe of the radiation pattern. Likewise, based on structures and characteristics of the structures near the vehicle 302, including a site of a building, a height of the building, a size of the building, and a construction of the building, a controller may select a different group of elements, such as a subset of all elements or shift a phase of the selected elements to concentrate the RF energy to form a main lobe of the radiation pattern. Regarding the construction of the building, the RF energy may be transmitted through the material, reflected by the material or absorbed within the material. The RF properties also may change based on the frequency of the RF energy.

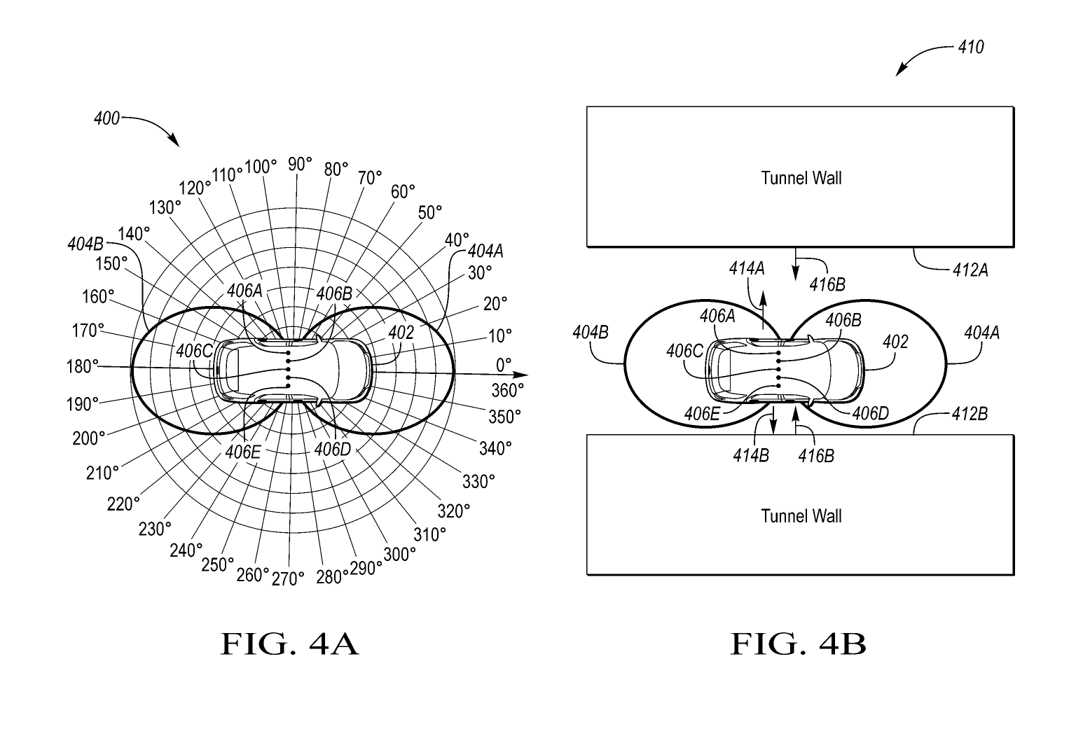

FIG. 4A is a 2-dimensional illustration of an antenna system 400 of a vehicle 402 configured to produce a radiation pattern 404 using a phased array antenna 406 of a vehicle having increased gain to a front of the vehicle and behind the vehicle. The ability to beam form the radiation pattern to create a main lobe to the front of the vehicle and/or behind the vehicle may include the selection of specific elements of the phased array antenna 406 and shifting a phase of each selected element of the phased array antenna. FIG. 4B is a 2-dimensional illustration of an antenna system 410 of the vehicle 402 configured to produce the radiation pattern 404 using phased array antenna 406 having increased gain to the front of the vehicle and behind the vehicle while a location of the vehicle is proximate to a tunnel wall 412. Here, the radiation pattern 404 is a 3 dimensional surface that when viewed along a single plane appears as a pair of lobes 404A and 404B. The radiation pattern 404 includes a portion of the pattern 404A transmitted into non-obstructing space in front of the vehicle and a portion of the pattern 404B transmitted into non-obstructing space behind the vehicle. The non-obstructed RF signal 414A and 414B transmitted do not contact any objects such as tunnel walls 412A or 412B and thus there are minimal reflections 416A and 416B.

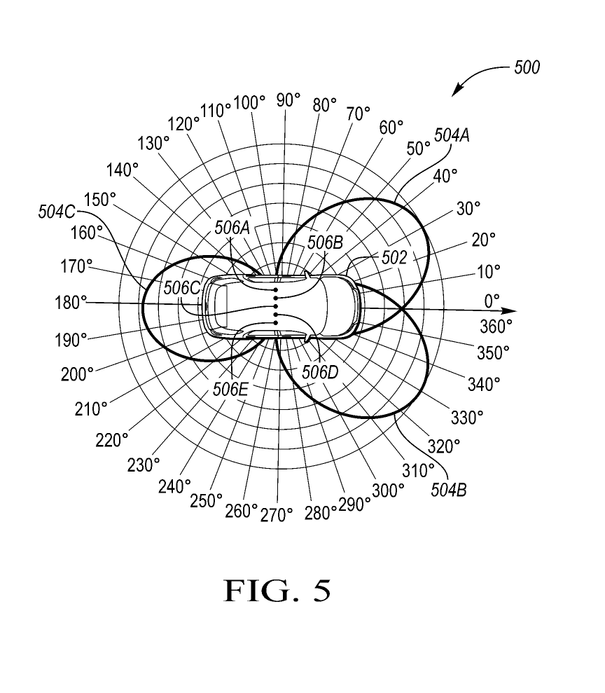

FIG. 5 is a 2-dimensional illustration of an antenna system 500 for a vehicle 502 configured to produce a radiation pattern 504 using a phased array antenna 506 coupled with the vehicle 502 having increased gain along 2 frontal lobes (504A, 504B) and behind 504C the vehicle.

The processes, methods, or algorithms disclosed herein may be deliverable to or implemented by a processing device, controller, or computer, which may include any existing programmable electronic control unit or dedicated electronic control unit. Similarly, the processes, methods, or algorithms may be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms may also be implemented in a software executable object. Alternatively, the processes, methods, or algorithms may be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A communication system for a vehicle comprising:
a phased array antenna having a plurality of elements; and
a controller configured to select a subset of the elements to beam form a main lobe of a radiation pattern of the antenna based on a speed and steering angle of the vehicle.

2. The system of claim 1, wherein the controller is further configured to select the subset of the elements based on a signal indicative of a location of the vehicle and a map database of a surrounding area of the location.

3. The system of claim 2, wherein the controller is further configured to select the subset of the elements based on a route generated by a navigation system.

4. The system of claim 2, wherein the map database is based on a cumulation of input from sensors associated with the surrounding area indicative of prior selection of elements, reception strength, a magnitude of reflections, or weather conditions.

5. The system of claim 2, wherein the map database includes a site of a building, a height of the building, a size of the building, or a construction of the building.

6. The system of claim 5, wherein the map database further includes a position of a wireless tower, and wherein the selection of the subset of the elements is based on the position.

7. The system of claim 2, wherein the controller is further configured to select the subset of the elements to concentrate the main lobe in at least two directions to a front of the vehicle based on the location of the vehicle approaching a cross street.

8. A communication system for a vehicle comprising:
a phased array antenna having a plurality of elements; and
a controller configured to select a subset of the elements and shift a phase of a signal emitted from each of the subset of the elements to beam form a main lobe of a radiation pattern of the antenna based on a speed and a change in speed of the vehicle.

9. The system of claim 8 further comprising a transceiver, and wherein the transceiver transmits the radiation pattern at greater than 3 GHz.

10. The system of claim 8, wherein the the controller is further configured to select the subset of the elements and shift the phase of the signal emitted from each of the subset of the elements based on a turn signal from a module of the vehicle indicative of activation of a turn direction indicator.

11. The system of claim 8, wherein the the controller is further configured to select the subset of the elements and shift the phase of the signal emitted from each of the subset of the elements based on a brake signal from a module of the vehicle indicative of application of a braking force.

12. The system of claim 8, wherein the the controller is further configured to select the subset of the elements and shift the phase of the signal emitted from each of the subset of the elements based on a steering angle.

13. The system of claim 8, wherein the controller is further configured to select the subset of the elements and shift the phase of the signal emitted from each of the subset of the elements based on a location of the vehicle and a map database of a surrounding area.

14. The system of claim 8, wherein the controller is further configured to select the subset of the elements and shift the phase of the signal emitted from each of the subset of the elements based on a route generated by a navigation system.

15. A vehicle comprising:
a phased array antenna having a plurality of elements; and
a controller configured to select a subset of the elements and shift a phase of a signal emitted from each of the subset of the elements to beam form a main lobe of a radiation pattern of the antenna based on a change in speed of the vehicle.

16. The vehicle of claim 15 further comprising a steering angle sensor coupled with the controller, wherein the controller is further configured to select the subset of the elements and shift the phase of the signal emitted from each of the subset of the elements to concentrate the main lobe of the radiation pattern in a direction of steering based on an output of the sensor.

17. The vehicle of claim 15 further comprising a wheel speed sensor coupled with the controller, wherein the controller is further configured to select the subset of the elements and shift the phase of the signal emitted from each of the subset of the elements to concentrate the main lobe of the radiation pattern in a frontal direction from the vehicle in proportion to an output of the sensor.

18. The vehicle of claim 15 further comprising an antilock brake module coupled with the controller, wherein the controller is further configured to select the subset of the elements and shift the phase of the signal emitted from each of the subset of the elements to concentrate the main lobe of the radiation pattern behind the vehicle based on an output of the module.

19. The vehicle of claim 18, wherein the controller is further configured to select the subset of the elements and shift the phase of the signal emitted from each of the subset of the elements to concentrate the main lobe of the radiation pattern behind the vehicle in proportion to a brake signal from the module indicative of a brake force.
